(19) United States
(12) Patent Application Publication
(10) Pub. No.: US 2016/0025626 A1
(43) Pub. Date: Jan. 28, 2016

(54) SILICON PHOTONIC CRYSTAL NANOBEAM CAVITY WITHOUT SURFACE CLADDING AND INTEGRATED WITH MICRO-HEATER FOR SENSING APPLICATIONS

(71) Applicant: CALIFORNIA INSTITUTE OF TECHNOLOGY, Pasadena, CA (US)

(72) Inventors: William DOS SANTOS FEGADOLLI, PASADENA, CA (US); Axel SCHERER, BARNARD, VT (US)

(21) Appl. No.: 14/801,162

(22) Filed: Jul. 16, 2015

Related U.S. Application Data
(60) Provisional application No. 62/028,135, filed on Jul. 23, 2014.

(51) Int. Cl. G01N 21/41; G01N 21/31

(52) U.S. Cl. CPC G01N 21/41; G01N 21/3103

(57) ABSTRACT

A silicon photonic crystal nanobeam cavity device is described, including a heater that can set a desired temperature on the cavity device in order to control its resonant wavelength. The device has no cladding, which is advantageous for sensing. Biosensing applications with temperature control can be carried out with the nanobeam cavity device.

### CROSS REFERENCE TO RELATED APPLICATIONS

The present application claims priority to U.S. Provisional Patent Application No. 62/028,135, filed on Jul. 23, 2014, and may be related to U.S. patent application Ser. No. 14/051,409 (Publication No. U.S. 2014/0161386), filed on Oct. 10, 2013, the disclosures of both of which are incorporated herein by reference in their entirety.

### TECHNICAL FIELD

The present disclosure relates to nanobeam cavity sensors. More particularly, it relates to silicon photonic crystal nanobeam cavity without surface cladding and integrated with micro-heater for sensing applications.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 illustrates thermal and optical simulations of a device with a top view of the 3D modeled structure.

FIG. 2 illustrates a theoretical Q-factor and the resonant wavelength as a function of the central cavity hole diameter and different values of cavity width.

FIG. 3 illustrates an exemplary nanobeam cavity integrated with a micro-heater at different magnifications.

FIG. 4 illustrates an exemplary device's optical response with and without bias current applied on the micro-heater.

FIG. 5 illustrates experimental electrical characteristics for an exemplary device of the present disclosure.

FIG. 6 illustrates the induced resonant shift for different binding chemistries and a comparison of the resonant shift of different mediums compared with DI water.

FIG. 7 shows the normalized optical power as a function of the wavelength without any material near the sensor surface.

### SUMMARY

In a first aspect of the disclosure, a device is described, the device comprising: a photonic crystal nanobeam cavity; a microheater configured to heat the photonic crystal nanobeam cavity; and at least two electrodes electrically connected to the microheater and configured to provide current to the microheater.

### DETAILED DESCRIPTION

The present disclosure describes a reconfigurable silicon photonic crystal nanobeam cavity without surface cladding, designed for sensing applications. The structures of the present disclosure can provide, for example, a high extinction ratio, such as 21 dB, tuning of the resonant wavelength of 6.8 nm, power efficiency of 0.015 nm/mW, temperature variation on the order of 100° C. inside the sensing region, as well as switching time as fast as 10 μs and 13 μs for rise and fall time, respectively. Such values for the physical parameters above are exemplary and other values may also be achieved with the structures of the present disclosure, both higher and lower of the values cited above.

The use of silicon photonics for sensing applications has become of great interest for scientific and industrial applications owing to its intrinsic compactness and compatibility with complementary metal oxide semiconductor (CMOS) fabrication processes, which bring the benefits of mature fabrication techniques and large scale manufacture at low cost.

Over the past years, researchers have demonstrated the detection of materials in the solid phase, see Refs. [1, 2], liquid phase, see Refs. [3, 4], and gas phase, see Refs. [5, 6], by using optical resonators and suitable techniques, see Refs. [1-9]. Amongst the variety of experiments already reported in the literature, two major approaches have been used as sensing mechanism: refractive index sensing and absorption sensing, see Refs. [8, 9]. The refractive index sensing mechanism is characteristic for its simplicity and robustness. This mechanism is based on the detection of a change in the refractive index induced by molecular binding near the resonator surface. The change in the refractive index is translated to a resonant wavelength shift. The selectivity or specificity of the optical sensor strongly relies on the functionalization performed around the surface of the optical resonator, which can be achieved by a suitable coating or other surface preparation processes [Refs. 6-9]. It is the functionalization process that allows the change in refractive index induced by molecular binding near the resonator surface.

Although these techniques are promising for multiple sensing purposes [Refs. 1-10], there are longstanding challenges that have limited several bio-sensing applications [Refs. 10, 11]. For example, the demonstration of polymerase chain reactions (PCR), among others, requires the ability to control levels of saturation and endothermic reactions, requiring a special device able to simultaneously detect and provide local heat [Refs. 10, 11]. Therefore, an optical device without surface cladding, able to interrogate bio-molecules and simultaneously provide local heat to promote particular chemical reactions on chip, is essential to overcome several challenges in this field [Refs. 11].

To date, most of the thermo-optical devices proposed in the literature were dedicated for telecommunications purposes, being usually composed of Si waveguides embedded on a SiO₂ buried oxide, and integrated with micro-heaters atop [Refs. 12, 13]. The fact that these devices are embedded on a thick SiO₂ layer eliminates the sensing capability, thus making such structures unsuitable for sensing applications.

To overcome this challenge, the present disclosure describes a specially designed structure based on a nanobeam cavity [Refs. 12, 14]. Due to its intrinsic claddingless nature, such a device is able to simultaneously sense the refractive index change of the materials near its surface [Ref. 6] as well as provide local heat to the optical resonator.

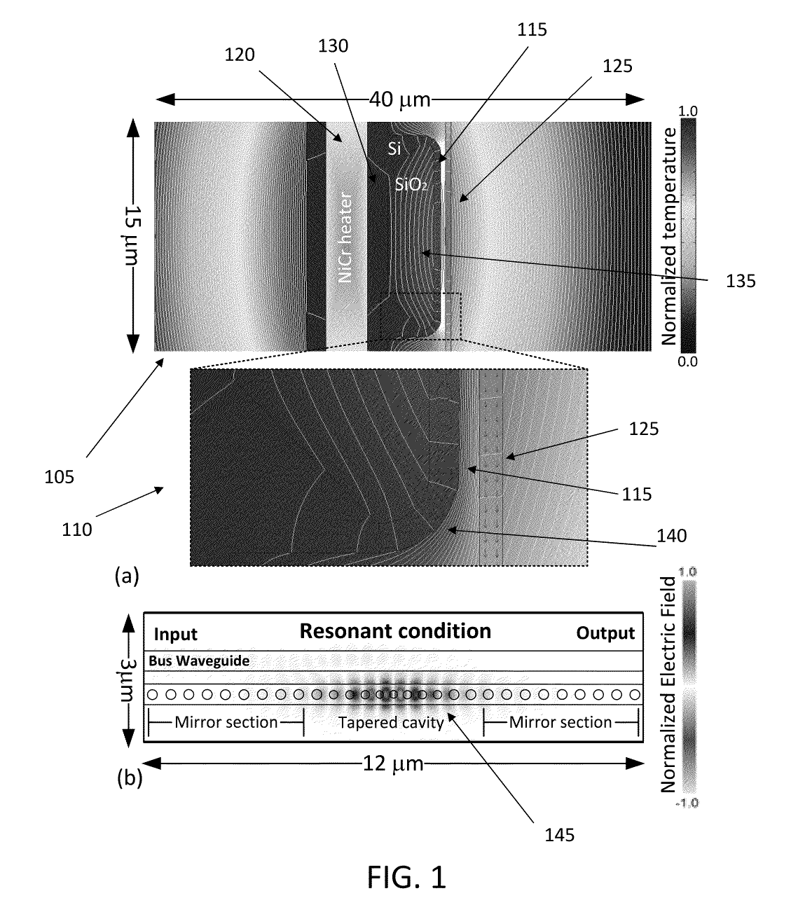

In FIG. 1, thermal simulations of the device under investigation are illustrated (105), with a top view of the 3D modeled structure. A zoomed picture of part of the device is also illustrated (110). The device consists of a photonic crystal nanobeam cavity (115) coupled to a bus waveguide (125), and connected to a silicon pad (130) integrated with a NiCr micro-heater. In some embodiments, different materials may be used other than NiCr. In some embodiments, the heat distribution is provided by a 15 um×4 um NiCr micro-heater on top of silicon pads. Other dimensions may be used for the micro-heater. The structure is not cladded and is built on top of a SiO₂ optical buffer layer (partly visible as 135). To connect the Si pad (130) to the cavity (115), in some embodiments tapered and/or round sections of Si (140) can be employed.

FIG. 1 shows thermal and optical simulations performed by 2D-Finite Elements and 3D-Finite Difference Time Domain (3D-FDTD), respectively. In FIG. 1: panel (a) illustrates theoretical thermal distribution provided by the micro-heater to the photonic crystal nanobeam cavity. The mapping arrows in panel (a) are normalized with respect to the total heat supplied. In FIG. 1, panel (b) illustrates a theoretical resonant optical mode profile for a photonic crystal nanobeam cavity.

The thermal layer was designed exploiting the principle of thermal conduction; the NiCr heater provides heat to the nanobeam cavity by means of the silicon pads that are connected to its extremities. The heat diffuses both into the Si and SiO₂ layers, with a higher level of heat diffusing into the silicon structure, due to its higher thermal conductivity, as can be observed in FIG. 1, panel (a) and its inset (the length of the mapping arrows are proportional to the total heat supplied). The heat delivered to the nanobeam cavity increases the refractive index of silicon, owing to its positive thermo-optical coefficient (1.84×10⁻⁴ K⁻¹,c see Refs. [12, 13]); consequently, the optical length of the cavity increases proportionally, allowing tuning of the resonant wavelength.

In other words, tuning of the resonant wavelength in the cavity is carried out through the application of heat by the heater. The thermal energy is primarily transferred to the Si cavity due to its higher thermal conductivity relative to the SiO₂ layers.

In some embodiments, the cavity (115) comprises holes, for example circular (cylindrical) holes, centered along the longitudinal axis of a Si parallelepiped.

The optical mode of the nanobeam cavity is concentrated only on the central region (145) of the device, as depicted in FIG. 1, panel (b); therefore, the optical resonant mode is excited by means of the bus waveguide adjacently coupled to the nanobeam cavity. This unique structure can simultaneously be optically and thermally excited. Owing to its intrinsic nature of being fabricated without surface cladding, it can be used for regular sensing applications, see Refs. [1-9], and sensing applications that simultaneously require local heating, see Ref [11].

The optical design of the proposed structure follows a similar approach reported in Ref. [12]. In some embodiments, the height of the cavity is 220 nm and the mirror section consists of nine holes with a periodicity of 425 nm and a diameter of 236 nm. In some embodiments, the central section of the cavity is precisely tapered with 11 holes to reduce the scattering losses and provide high phase matching between the photonic crystal Bloch mode and the waveguide mode, see Ref. [12].

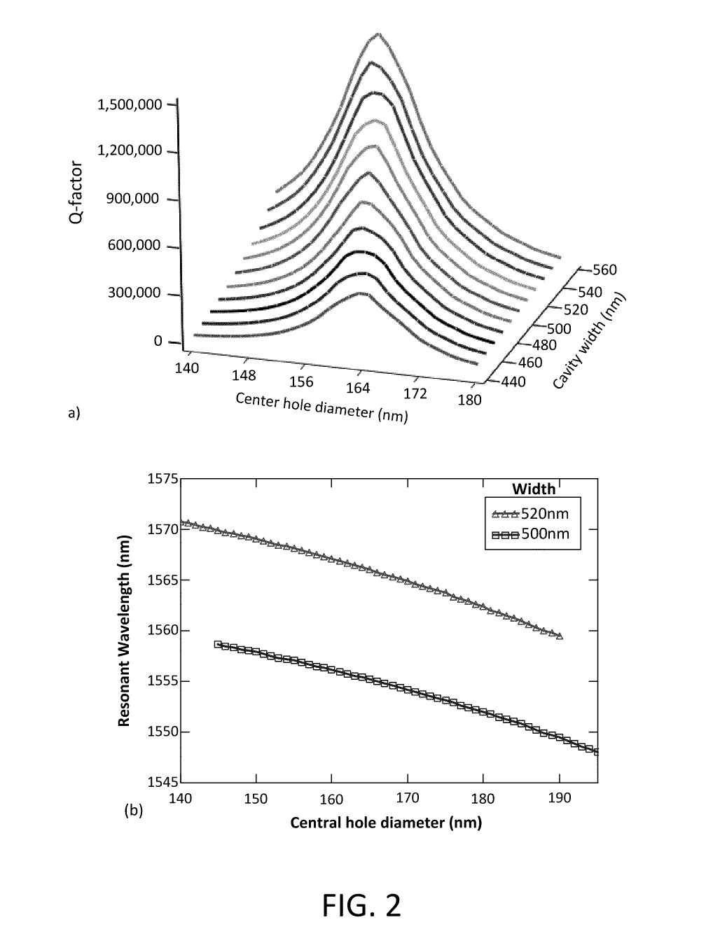

Additionally, compared to Ref. [12], the theoretical Q-factor of the cavity was optimized by choosing a suitable width and diameter of the central hole in the cavity. FIG. 2, panel (a) illustrates a theoretical Q-factor and FIG. 2, panel (b) the resonant wavelength as a function of the central cavity hole diameter and different values of cavity width.

FIG. 2, panel (a) illustrates the theoretical absolute Q-factor as a function of the central hole diameter in a nanobeam cavity, for different values of cavity width without loading effect. FIG. 2, panel (b), illustrates that a deviation of a few nanometers in only one of the parameters can significantly modify the operational wavelength and reduce the Q-factor of the cavity.

Based on the results of the theoretical investigation, the optimized design parameters were selected based on the simulations. The present disclosure therefore describes how the Q- factor of the cavity is chosen based on the cavity width and the diameter of the central holes in the cavity.

To fabricate the structure, in a first step the optical layer is exposed by lithography techniques. For example, by means of electron-beam lithography using negative tone e-beam resist (such as XR-1541-HSQ). Subsequently, the sample is developed and then etched, for example by means of a plasma etching using a mixture of C₄F₈ and SF₆ to define the optical waveguides and the Si pads.

The metallic layer can be fabricated by two steps of photolithography in order to define the micro-heater and the contact pads. First, the micro-heater can be defined by means of a single aligned step of photolithography, followed by development and deposition of NiCr, for example 200 nm. Subsequently, lift-off step is performed to remove the excess material. An additional step of aligned photolithography can be performed to define the contact pads, followed by developing and two-step-deposition of titanium (for example 10 nm) and gold (for example 270 nm), and then lift-off to complete the contact lines.

In some embodiments, SiO₂ plasma-enhanced chemical vapor deposition (PECVD) can be carried out on top of the entire structure, for passivation, followed by a photolithographic step and a wet etch to open a window around the contact pads and create a fluid environment around the sensing area, so that its sensing capability could be preserved.

In other embodiments, a photolithographic step can be carried out, for example using SU-8 to clad the input/output waveguides, but keeping an open window around the device, so that its sensing capability can be preserved. Finally, the device can be packaged using a customized mechanical housing; tapered optical fibers to maintain polarization can be coupled to the silicon chip and electrical contacts can be wire-bonded. Alternative methods of fabrication may be used to obtain the structures described in the present disclosure.

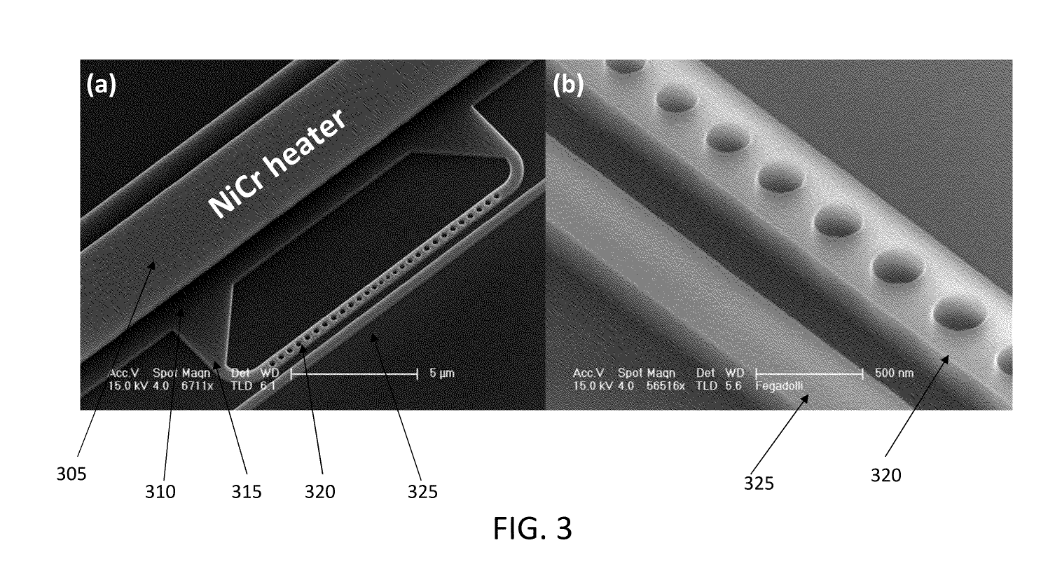

An exemplary device is shown in FIG. 3. In FIG. 3, panel (a) and panel (b) show the fabricated nanobeam cavity integrated with the micro-heater at different magnifications. FIG. 3 illustrates a heater (305), connected to a Si pad (310), with tapered and rounded portions (315) that connect to a cavity (320) with holes, the cavity being coupled to the waveguide (325). FIG. 3 illustrates fabricated heater-based photonic crystal nanobeam cavity under different magnifications.

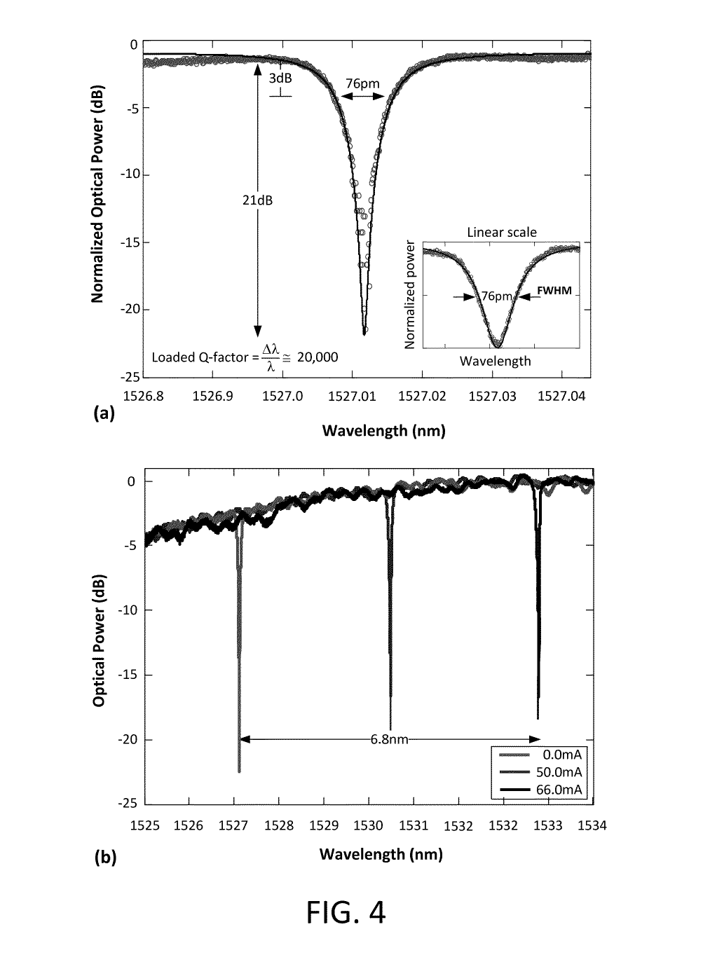

After fabrication, an exemplary device was tested using a tunable laser, an electrical pulse generator, and a high precision multimeter to analyze its figures-of-merit. FIG. 4, panel (a) shows the device's optical response of the resonator, the maximum extinction ratio observed in his exemplary device is 21 dB, for the Quasi-TE_{N} polarization and the loaded Q-factor is around 20,000. However, in other embodiments the devices of the present disclosure may have different parameters, for example a different maximum extinction ratio. FIG. 4, panel (b) shows the device's optical response for different values of electrical current applied on the micro-heater. FIG. 4 illustrates an exemplary device's optical response with and without bias current applied on the micro-heater.

Based on FIG. 4, it is possible to see that the resonant wavelength for this embodiment differs from the theoretical values. This is due to the fact that, in some embodiments, there is a deviation in the fabrication process which causes the diameter of the holes and the width of the cavity in the fabricated device to accumulate intrinsic and random deviations of up to ±8%. This variation in the fabrication process explains the discrepancy between theoretical and experimental results. However, the person skilled in the art will understand that, in other embodiments, such discrepancy will not be found as deviations in the fabrication process are removed.

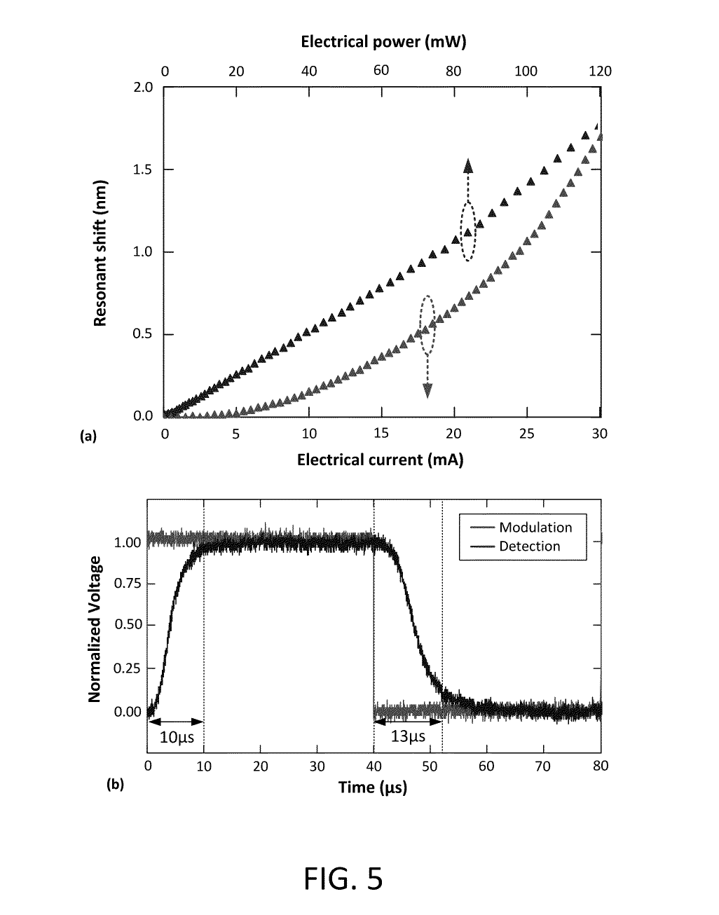

The behavior of the resonant shift was investigated as a function of the electrical current and power applied on the micro-heater. Experimental results show that the resistance and electro-optic power efficiency of the device are approximately 130 Q and 0.015 nm/mW, respectively. The resonant shift as a function of the electrical power and current are shown in FIG. 5, panel (a).

Based on the experimental results, it can be noted that the maximum electrical current applied on the micro-heater, in one embodiment, is 66 mA (or about 566 mW), which corresponds to a maximum resonant shift of up to 6.8 nm. For electrical currents beyond this threshold, physical damage was observed for the micro-heater. The person of ordinary skill in the art will understand that in other embodiments a higher maximum resonant shift may also be found.

In order to translate the resonant shift of 6.8 nm in terms of temperature change inside the nanobeam cavity, the evolution of the resonant peak can be simulated, as a function of the temperature. A linear coefficient of approximately 0.07 nm/° C. can be estimated. This allows estimating a temperature variation inside the nanobeam cavity of 98° C. before the heater melting down, for this specific embodiment.

It is also possible to verify how fast the device is able to switch the resonance. For example, a squared electrical signal can be applied to the micro-heater, with enough voltage to switch the resonance from an off to on condition. The modulated optical signal can be detected by means of a photodetector coupled to an oscilloscope. The experimental results for this embodiment are shown in FIG. 5. In FIG. 5, panel (b), it is possible to observe that the rise and fall time are 10 μs and 13 μs, respectively. This result shows a faster response compared to the approaches using SiO₂ embedded structures with heater atop, see Ref [12].

As explained above in the present disclosure, photonic crystal nanobeam cavities with high-quality factors are very sensitive to the changes of the dielectric properties of their surroundings. Combining this high sensitivity with a special designed heater, a sensitive optical sensor able to simultaneously provide heat and interrogate the refractive index of its surroundings can be demonstrated. The structure is able perform detection with experimental sensitivity of 97 nm/RIU and provide approximately 100° C. of temperature variation in the sensing area, as well as providing and temperature switching time of few microseconds.

An exemplary packaged device according to an embodiment of the present disclosure, using edge coupling design and lensed fibers, can be found in Ref. [15].

In summary, in the present disclosure a reconfigurable nanobeam cavity is described, that is able to simultaneously detect particles near its surface, owing to its intrinsic claddingless capability, as well as quickly increase the temperature inside the sensing area. The results reported in the present disclosure indicate that such a structure may offer the potential to achieve, for on-chip scale, fast bio-chemical diagnostics that require control of saturation and endothermic reactions. Such an on-chip capability also offers the potential to develop novel multiplexed sensing techniques for bio-medical diagnosis and sensing applications in general.

In some embodiments, a silicon pad connects the microheater to the nanobeam cavity. The silicon pad can comprise a central region adjacent to the microheater, and two silicon tapered pads, each silicon tapered pad at each end of the photonic crystal nanobeam cavity. The photonic crystal nanobeam cavity, the waveguide, and the silicon pad can be coplanar layers on a silicon dioxide substrate. The microheater can be a layer on top of part of the silicon pad, as visible for example in FIG. 3.

In some embodiments, the photonic crystal nanobeam cavity comprises a functionalization layer. For example, a functionalization layer could comprise a gold layer that can be functionalized with biological agents. These biological agents can then bind with other biological entities. This capture event can be detected by the functionalization layer. Other methods may be used for functionalization that does not involve a metal, to allow unimpeded transmission of light.

The sensing capability of one embodiment of the devices of the present disclosure was characterized by means of four different detections using no surface functionalization, where a new sensing device was used for each one of the tests (different chips but same fabrication batch). To perform such an experiment, the cover medium was introduced on each one of four sensors' surface with deionized water (DI water), saline-sodium citrate (SSC) buffer, Tris-Buffered Saline and Tween 20 (TBST), and Phosphate buffered saline (PBS), respectively. The induced resonant shift caused by the change of refractive index around the surface of the resonator was investigated, with the results shown in FIG. 8.

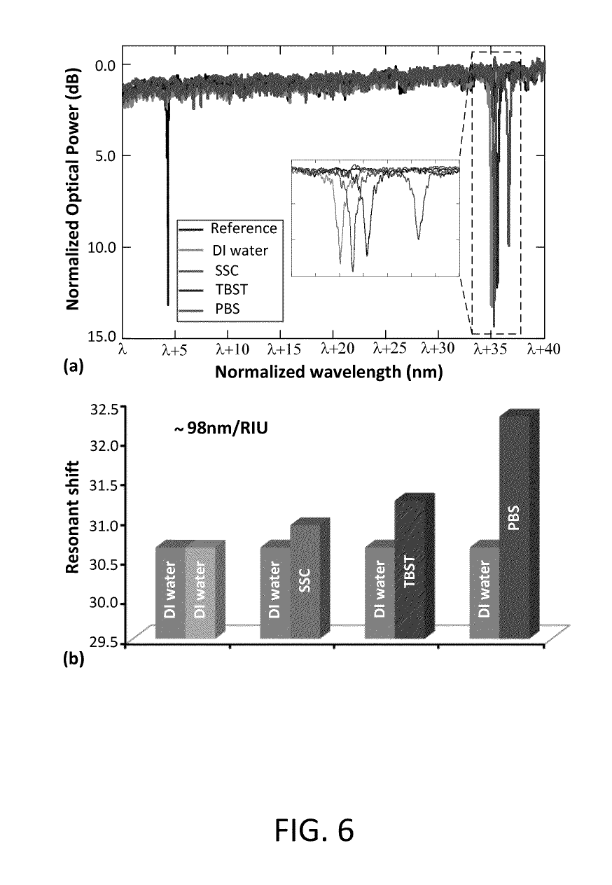

FIG. 6 illustrates in panel (a) the induced resonant shift for different binding chemistries and in panel (b) a comparison of the resonant shift of different mediums compared with DI water. A normalized optical wavelength was assumed in FIG. 6, panel (a), because each one of the optical resonators used in the experiment presented a slightly different resonant wavelength owing to the intrinsic deviations during the fabrication process. Therefore, the single resonant peak named as reference in FIG. 8 shows a single reference peak that represent the four resonators used in all the experiments.

FIG. 6, panel (b) shows a comparison among the resonant shift of the chemicals used in this experiment and DI water, showing that the device can interrogate biochemical signatures of different materials with low refractive index contrast, since all solutions are water based. The experiment was repeated several times with different samples and no significant discrepancy was observed regarding the resonant wavelength readout.

In order to infer the experimental device's sensitivity, one can consider the DI water refractive index as 1.318 (see Ref. [16]) and the wavelength shift observed in our experiments, resulting in a sensitivity of approximately 98 nm/RIU, which is consistent with the theoretical result obtained from 3D-FDTD simulations, 100 nm/RIU.

A further experiment was performed, investigating the simultaneous capability of applying heat and interrogating the refractive index near the surface of the sensor. FIG. 9 shows the normalized optical power as a function of the wavelength without any material near the sensor surface, with DI water, and with DI water plus heat provided to the resonator by means of a 10 mA electrical current.

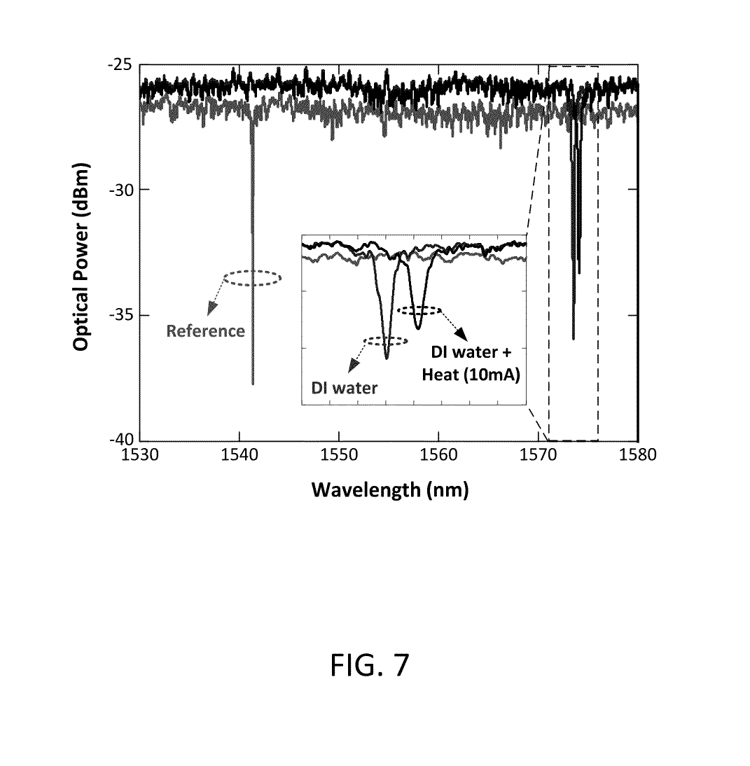

Based on FIG. 7, it is possible to observe that the device is able to simultaneously interrogate and heat up materials near the surface of the nanobeam cavity. In addition, it was possible to observe the formation of water bubbles, when the heater reached temperatures around 100° C., by means of an optical microscope coupled on top of the optical testing setup while the tests were performed.

In summary, the results reported in this letter indicate that such a structure may offer the potential to achieve, for on-chip scale devices, the simultaneous capabilities of interrogating and providing heat, which offer potential to reach applications of use in bio-chemical diagnostics that require local temperature control. Such an on-chip capability also offers potential to develop novel multiplexed sensing techniques for bio-medical diagnosis and sensing applications in general, extending the concept shown in the present disclosure to a variety of materials in different phases.

As explained above, one advantage of the devices of the present disclosure is the absence of a cladding layer. In other types of devices, the Si waveguides and cavity are deposited onto a silicon dioxide layer. Additionally, a silicon dioxide cladding layer is deposited around and on top of the Si waveguides and cavity. The heater is then deposited on top of the cladding layer. Therefore, in these types of devices a cladding layer separates the Si waveguides and cavity from the heater layer. By contrast, in the devices of the present disclosure, this cladding layer is absent, therefore the heater is directly in contact with a silicon pad, which in turn is directly in contact with the Si cavity. The absence of the cladding layer allows a sensing function not possible with devices that have a cladding layer.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The references in the present application, shown in the reference list below, are incorporated herein by reference in their entirety.

### REFERENCES

1. Bradley Schmidt, Vilson Almeida, C. Manolatou, Stefan Preble and M. Lipson, “Nanocavity in a silicon waveguide for ultra sensitive detection,” Applied Physics Letters 85, 4854-4856 (2004).
2. Mindy R. Lee and Philippe M. Fauchet, “Nanoscale microcavity sensor for single particle detection,” Opt. Lett. 32, 3284-3286 (2007).
3. Yoav Zuta, Ilya Goykhman, Boris Desiatov, and Uriel Levy, “On-chip switching of a silicon nitride micro-ring resonator based on digital microfluidics platform,” Opt. Express 18, 24762-24769 (2010).
4. Y. Liu and H. W. M. Salemink, “Photonic crystal-based all-optical on-chip sensor,” Opt. Express 20, 19912-19920 (2012).
5. Yu Chen, William S. Fegadolli, William M. Jones, Axel Scherer, and Mo Li, “Ultrasensitive Gas-Phase Chemical Sensing Based on Functionalized Photonic Crystal Nanobeam Cavities,” ACS Nano 8 (1), 522-527, (2014).
6. Jacob T. Robinson, Long Chen, and Michal Lipson, “On-chip gas detection in silicon optical microcavities,” Opt. Express16, 4296-4301 (2008).
7. K. De Vos, I. Bartolozzi, E. Schacht, P. Bienstman, and R. Baets, “Silicon-on-insulator microring resonator for sensitive and label-free biosensing,” Opt. Express 15, 7610-7615 (2007).
8. R. Boyd and J. Heebner, “Sensitive disk resonator photonic biosensor,” Appl. Opt. 40, 5742-5747 (2001).
9. Juejun Hu, Xiaochen Sun, Anu Agarwal, and Lionel C. Kimerling, “Design guidelines for optical resonator biochemical sensors,” J. Opt. Soc. Am. B 26, 1032-1041 (2009).
10. M. Zourob and A. Lakhtakia, eds., Optical Guided-Wave Chemical and Biosensors I, Springer, (2010).
11. Bartlett, J. M. S.; Stirling, D. “A Short History of the Polymerase Chain Reaction”. PCR Protocols 226. (2003).
12. William S. Fegadolli, Jose E. B. Oliveira, Vilson R. Almeida, and Axel Scherer, “Compact and low power consumption tunable photonic crystal nanobeam cavity,” Opt. Express 21, 3861-3871 (2013).
13. A. H. Atabaki, E. S. Hosseini, A. A. Eftekhar, S. Yegnanarayanan, and A. Adibi, “Optimization of metallic microheaters for high-speed reconfigurable silicon photonics,” Opt. Express 18, 18312-18323 (2010).
14. P. B. Deotare, M. W. McCutcheon, I. W. Frank, M. Khan, and M. Loncar, “High quality factor photonic crystal nanobeam cavities,” Appl. Phys. Lett.94(12), 121106 (2009).
15. V. R. Almeida, R. R. Panepucci, and M. Lipson, “Nanotaper for compact mode conversion,” Opt. Lett. 28(15), 1302-1304 (2003).
16. George M. Hale and Marvin R. Querry, “Optical Constants of Water in the 200-nm to 200-μm Wavelength Region,” Appl. Opt. 12, 555-563 (1973).

What is claimed is:

1. A device comprising:
a photonic crystal nanobeam cavity;
a microheater configured to heat the photonic crystal nanobeam cavity; and
at least two electrodes electrically connected to the microheater and configured to provide current to the microheater.

2. The device of claim 1, wherein the photonic crystal nanobeam cavity comprises a plurality of cylindrical holes centered along its longitudinal axis.

3. The device of claim 2, further comprising a waveguide optically coupled to the photonic crystal nanobeam cavity.

4. The device of claim 3, wherein the photonic crystal nanobeam cavity is silicon.

5. The device of claim 4, further comprising a silicon pad thermally connecting the microheater to the photonic crystal nanobeam cavity.

6. The device of claim 5, wherein the silicon pad comprises:
a central region adjacent to the microheater; and
two silicon tapered pads, each silicon tapered pad at each end of the photonic crystal nanobeam cavity.

7. The device of claim 6, wherein the microheater is NiCr.

8. The device of claim 7, wherein the photonic crystal nanobeam cavity, the waveguide, and the silicon pad are coplanar layers on a silicon dioxide substrate.

9. The device of claim 8, wherein the microheater is a layer on top of the central region of the silicon pad.

10. The device of claim 9, wherein the photonic crystal nanobeam cavity has a height of 220 nm and the cylindrical holes have a periodicity of 425 nm and a diameter of 236 nm.

11. The device of claim 10, wherein the cylindrical holes are nine or eleven.

12. The device of claim 11, wherein the photonic crystal nanobeam cavity has an extinction ratio of 21 dB.

13. The device of claim 12, wherein the photonic crystal nanobeam cavity has a resonant wavelength tuning of 6.8 nm.

14. The device of claim 13, wherein the photonic crystal nanobeam cavity has a power efficiency of 0.015 nm/mW.

15. The device of claim 14, wherein the device is for biosensing.

16. The device of claim 15, further comprising a functionalization layer on top of the photonic crystal nanobeam cavity.
